(19) United States
(12) Patent Application Publication
(10) Pub. No.: US 2007/0089560 A1
(43) Pub. Date: Apr. 26, 2007

(54) Crank axle drive structure for bicycle

(76) Inventors: Chin-Chou Lai, Hua Tarn Hsiang (TW); Bill Huang, Changhua (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/258,514

(22) Filed: Oct. 25, 2005

(51) Int. Cl. G05G 1/14

(52) U.S. Cl. 74/594.1

(57) ABSTRACT

A crank axle drive structure for a bicycle includes a bottom bracket having inner teeth, a crank axle rotatably mounted in the bottom bracket, at least one drive gear rotatably mounted on the crank axle and meshing with the inner teeth, and a chainwheel fixing seat rotatably mounted on the crank axle and provided with outer teeth meshing with the drive gear. Thus, the inner teeth of the bottom bracket have a tooth number greater than that of the outer teeth of the chainwheel fixing seat, so that the rotation speed of the chainwheel fixing seat is increased, thereby shortening the diameter of the chainwheel so as to perform a pedaling action at the higher rotation speed in an energy saving manner.

### BACKGROUND OF THE INVENTION

1. Field of the Invention

The present invention relates to a crank axle drive structure, and more particularly to a crank axle drive structure for a bicycle.

2. Description of the Related Art

A crank axle of a bicycle has an end provided with a chainwheel, a chain and a flywheel. Thus, when the crank axle is rotated, the chainwheel, the chain and the flywheel are driven by the crank axle drives to rotate in concert with the crank axle. The chainwheel has a tooth number greater than that of the flywheel. When the diameter of the chainwheel is shortened, the rider can apply a smaller force on the chainwheel, thereby saving the manual work. However, when the diameter of the chainwheel is shortened, the rotation speed of the chainwheel is reduced, thereby reducing the speed of the bicycle. Thus, the specification of the conventional chainwheel is limited.

### SUMMARY OF THE INVENTION

In accordance with the present invention, there is provided a crank axle drive structure, comprising a bottom bracket having an inner wall provided with a plurality of inner teeth, a crank axle rotatably mounted in the bottom bracket, at least one drive gear rotatably mounted on the crank axle and meshing with the inner teeth of the bottom bracket, and a chainwheel fixing seat rotatably mounted on the crank axle and provided with a plurality of outer teeth meshing with the drive gear.

The primary objective of the present invention is to provide a crank axle drive structure, wherein the diameter of the chainwheel is shortened without reducing the rotation speed of the chainwheel.

Another objective of the present invention is to provide a crank axle drive structure, wherein the specification of the chainwheel is shortened efficiently, so that the crank axle drive structure has a simplified construction, thereby decreasing costs of fabrication.

A further objective of the present invention is to provide a crank axle drive structure, wherein the chainwheel has a smaller size, so that the force applied on the crank axle is reduced, thereby saving the manual work.

A further objective of the present invention is to provide a crank axle drive structure, wherein the chainwheel has a smaller size and a lighter weight, so that the crank axle drive structure has a smaller volume, thereby facilitating package, storage and transportation of the crank axle drive structure.

A further objective of the present invention is to provide a crank axle drive structure, wherein the inner teeth of the bottom bracket have a tooth number greater than that of the outer teeth of the chainwheel fixing seat, so that the rotation speed of the chainwheel fixing seat is increased, thereby shortening the diameter of the chainwheel so as to perform a pedaling action at the higher rotation speed in an energy saving manner.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a crank axle drive structure in accordance with the preferred embodiment of the present invention.

FIG. 2 is an exploded perspective view of the crank axle drive structure as shown in FIG. 1.

FIG. 3 is a plan cross-sectional view of the crank axle drive structure as shown in FIG. 1.

FIG. 4 is a cross-sectional view of the crank axle drive structure taken along line 4-4 as shown in FIG. 3.

### DETAILED DESCRIPTION OF THE INVENTION

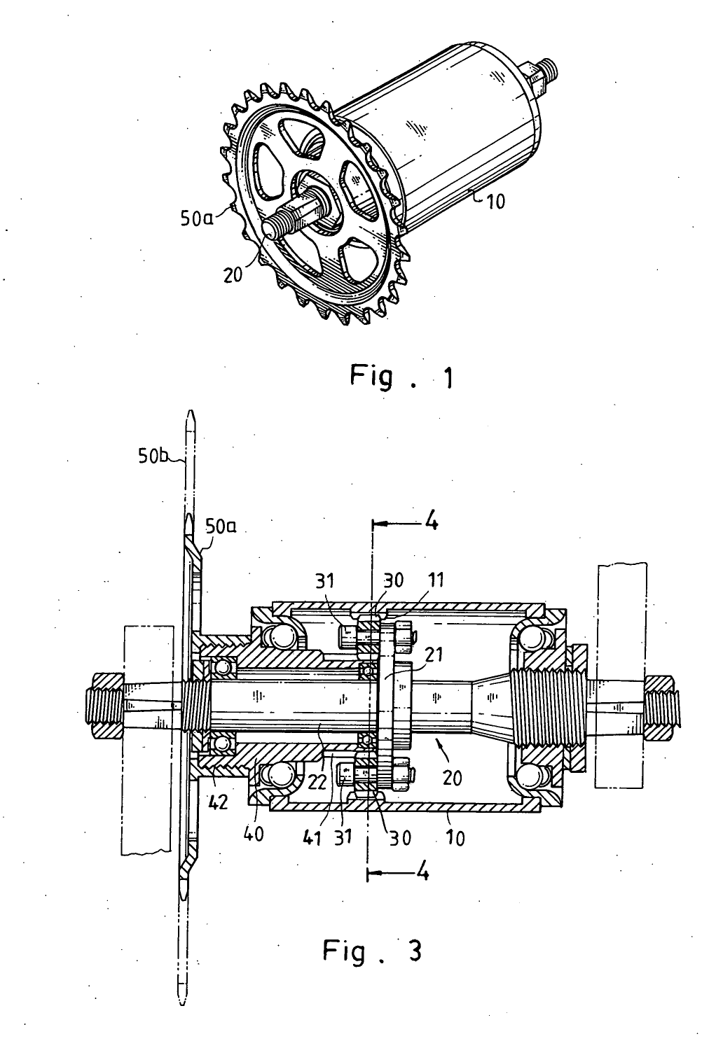

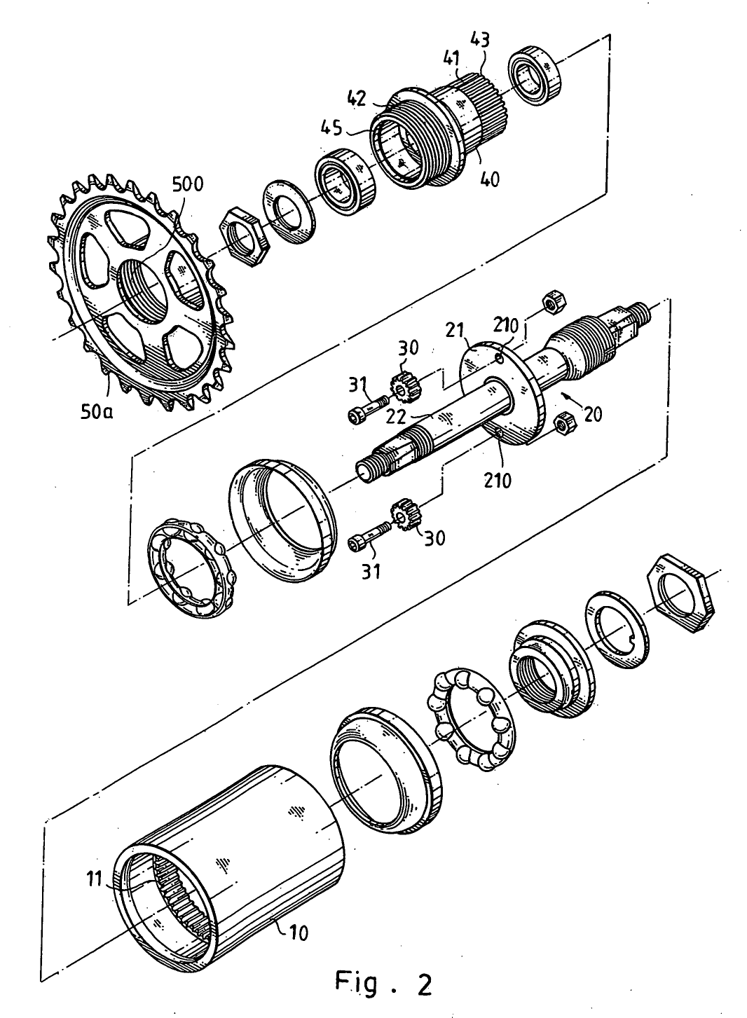

Referring to the drawings and initially to FIGS. 1-3, a crank axle drive structure for a bicycle in accordance with the preferred embodiment of the present invention comprises a bottom bracket 10 having an inner wall provided with a plurality of inner teeth 11, a crank axle 20 rotatably mounted in the bottom bracket 10, at least one drive gear 30 rotatably mounted on the crank axle 20 and meshing with the inner teeth 11 of the bottom bracket 10, a chainwheel fixing seat 40 rotatably mounted on the crank axle 20 and provided with a plurality of outer teeth 41 meshing with the drive gear 30, and a chainwheel 50a secured to the chainwheel fixing seat 40 to rotate therewith. In the preferred embodiment of the present invention, the crank axle drive structure comprises two opposite drive gears 30 rotatably mounted on the crank axle 20 and arranged in a symmetric manner.

The inner teeth 11 of the bottom bracket 10 are arranged in the bottom bracket 10 in an annular manner.

The crank axle 20 includes a shaft 22 rotatably mounted in the bottom bracket 10, and a disk 21 secured on the shaft 22. The drive gear 30 is rotatably mounted on the disk 21 of the crank axle 20 and partially protruded outward from the disk 21 of the crank axle 20. The disk 21 of the crank axle 20 has a periphery formed with at least one through hole 210, and the crank axle drive structure further comprises at least one pivot pin 31 extended through the drive gear 30 and the through hole 210 of the disk 21 of the crank axle 20 so that the drive gear 30 is rotatable about the pivot pin 31.

The drive gear 30 is meshing with and located between the outer teeth 41 of the chainwheel fixing seat 40 and the inner teeth 11 of the bottom bracket 10.

The chainwheel fixing seat 40 is rotatably mounted on the shaft 22 of the crank axle 20, and the outer teeth 41 of the chainwheel fixing seat 40 are located between the shaft 22 of the crank axle 20 and the drive gear 30. The chainwheel fixing seat 40 has a first end having an outer wall provided with the outer teeth 41. The outer teeth 41 of the chainwheel fixing seat 40 are arranged on the first end of the chainwheel fixing seat 40 in an annular manner.

The chainwheel 50a is secured to a second end of the chainwheel fixing seat 40. The chainwheel 50a has an inside formed with an inner thread 500, and the second end of the chainwheel fixing seat 40 has an outer wall formed with an outer thread 42 screwed into the inner thread 500 of the chainwheel 50a.

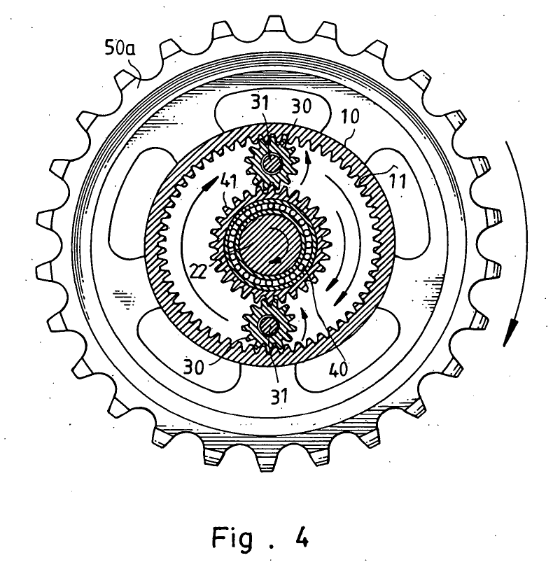

In operation, referring to FIGS. 1-4, when the shaft 22 of the crank axle 20 is rotated clockwise as shown in FIG. 4, the disk 21 of the crank axle 20 is rotated, so that the drive gear 30 is moved with the disk 21 of the crank axle 20. At this time, the drive gear 30 meshes with the inner teeth 11 of the bottom bracket 10, so that when the drive gear 30 is moved by the disk 21 of the crank axle 20, the drive gear 30 is rotated counterclockwise on the inner teeth 11 of the bottom bracket 10 like a planet. In addition, the outer teeth 41 of the chainwheel fixing seat 40 meshes with the drive gear 30, so that when the drive gear 30 is rotated counterclockwise, the chainwheel fixing seat 40 is rotated clockwise by the drive gear 30, and the chainwheel 50a is rotated clockwise. Thus, the chainwheel 50a and the shaft 22 of the crank axle 20 are rotated at the same direction. The inner teeth 11 of the bottom bracket 10 have a tooth number greater than that of the outer teeth 41 of the chainwheel fixing seat 40, so that the rotation speed of the chainwheel fixing seat 40 is increased by the tooth number differential between the outer teeth 41 of the chainwheel fixing seat 40 and the inner teeth 11 of the bottom bracket 10. Thus, the chainwheel 50a has a relatively smaller size and tooth number than that of a conventional chainwheel 50b as shown in FIG. 4; and has the same rotation speed as that of the conventional chainwheel 50b under the condition of the same pedaling cycle number.

Accordingly, the specification of the chainwheel 50a is shortened efficiently, so that the crank axle drive structure has a simplified construction, thereby decreasing costs of fabrication. In addition, the chainwheel 50a has a smaller size, so that the force applied on the crank axle 20 is reduced, thereby saving the manual work. Further, the chainwheel 50a has a smaller size and a lighter weight, so that the crank axle drive structure has a smaller volume, thereby facilitating package, storage and transportation of the crank axle drive structure. Further, the inner teeth 11 of the bottom bracket 10 have a tooth number greater than that of the outer teeth 41 of the chainwheel fixing seat 40, so that the rotation speed of the chainwheel fixing seat 40 is increased, thereby shortening the diameter of the chainwheel 50a so as to perform a pedaling action at the higher rotation speed in an energy saving manner.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A crank axle drive structure, comprising:
a stationary bottom bracket having an inner wall provided with a plurality of inner teeth;
a crank axle rotatably mounted in the bottom bracket;
at least one drive gear rotatably mounted on and supported by the crank axle to move with the crank axle rotatably by rotation of the crank axle and meshing with the inner teeth of the bottom bracket;
a chainwheel fixing seat rotatably mounted on the crank axle and provided with a plurality of outer teeth meshing with the drive gear;
wherein the drive gear intermeshes between the inner teeth of the bottom bracket and the outer teeth of the chainwheel fixing seat to drive the chainwheel fixing seat to be rotatable relative to the bottom bracket by rotation of the crank axle.

2. The crank axle drive structure in accordance with claim 1, wherein the crank axle includes a shaft rotatably mounted in the bottom bracket and having two opposite ends each protruding from the bottom bracket, and a disk secured on the shaft to rotate with the shaft and fully hidden in the bottom bracket.

3. The crank axle drive structure in accordance with claim 2, wherein the drive gear is rotatably mounted on the disk of the crank axle and having an outer rim partially protruded outward from an outer rim of the disk of the crank axle.

4. The crank axle drive structure in accordance with claim 2, wherein the disk of the crank axle has a periphery formed with at least one through hole, and the crank axle drive structure further comprises at least one pivot pin extended through the drive gear and the through hole of the disk of the crank axle so that the drive gear is rotatable about the pivot pin relative to the disk of the crank axle.

5. The crank axle drive structure in accordance with claim 2, wherein the chainwheel fixing seat is rotatably mounted on the shaft of the crank axle and rested on and rotatable relative to the disk of the crank axle.

6. The crank axle drive structure in accordance with claim 2, wherein the outer teeth of the chainwheel fixing seat are press fit and located between the shaft of the crank axle and the drive gear.

7. The crank axle drive structure in accordance with claim 1, wherein the drive gear is meshing with press fit and located between the outer teeth of the chainwheel fixing seat and the inner teeth of the bottom bracket.

8. The crank axle drive structure in accordance with claim 1, wherein the inner teeth of the bottom bracket are arranged in the bottom bracket in an annular manner.

9. The crank axle drive structure in accordance with claim 1, wherein the chainwheel fixing seat has a first end fully hidden in the bottom bracket and provided with the outer teeth.

10. The crank axle drive structure in accordance with claim 9, wherein the outer teeth of the chainwheel fixing seat are arranged on the first end of the chainwheel fixing seat in an annular manner.

11. The crank axle drive structure in accordance with claim 9, further comprising a chainwheel secured to the chainwheel fixing seat to rotate with the chainwheel fixing seat by rotation of the crank axle.

12. The crank axle drive structure in accordance with claim 11, wherein the chainwheel is secured to a second end of the chainwheel fixing seat and protruding from the bottom bracket.

13. The crank axle drive structure in accordance with claim 11, wherein the chainwheel has an inside formed with an inner thread, and the second end of the chainwheel fixing seat protrudes from the bottom bracket and has an outer thread screwed into the inner thread of the chainwheel.

14. The crank axle drive structure in accordance with claim 1, wherein the crank axle drive structure comprises two radially opposite drive gears rotatably mounted on the crank axle and arranged in a symmetric manner around the outer teeth of the chainwheel fixing seat.

15. The crank axle drive structure in accordance with claim 11, wherein the inner teeth of the bottom bracket have a tooth number greater than that of the outer teeth of the chainwheel fixing seat, so that a rotation speed of the chainwheel fixing seat is increased by a tooth number differential between the outer teeth of the chainwheel fixing seat and the inner teeth of the bottom bracket to reduce a size of the chainwheel so save a user's energy and to increase a rotation speed of the chainwheel.

16. The crank axle drive structure in accordance with claim 11, wherein when the crank axle is rotatable relative to the bottom bracket, the drive gear is movable with the crank axle and rotatable relative to the crank axle to drive the chainwheel fixing seat to be rotatable relative to the bottom bracket so as to drive the chainwheel to be rotatable relative to the bottom bracket.
